(19) United States
(12) Patent Application Publication
(10) Pub. No.: US 2021/0301946 A1
(43) Pub. Date: Sep. 30, 2021

(54) METHOD FOR CONTROLLING BUCKLING IN DEEPWATER PIPELINE WITH BUOYANCY MODULES

(71) Applicant: SHELL OIL COMPANY, HOUSTON, TX (US)

(72) Inventors: Michael Hosokawa DUPRE, Houston, TX (US); Kevin OUYANG, Houston, TX (US); Donald Christopher NELSON, Houston, TX (US)

(21) Appl. No.: 17/209,550

(22) Filed: Mar. 23, 2021

Related U.S. Application Data
(60) Provisional application No. 62/994,515, filed on Mar. 25, 2020.

(51) Int. Cl. F16L 1/24; E21B 17/01

(52) U.S. Cl. CPC F16L 1/24; E21B 17/015; E21B 17/012

(57) ABSTRACT

A method for controlling buckling in subsea pipelines involves identifying spaced-apart sections of a subsea pipeline suitable for controlled lateral buckling. Sets of buoyancy modules are installed at each spaced-apart section and are selected to support the spaced-apart sections of the subsea pipeline in a neutrally buoyant condition at the seafloor when the subsea pipeline is in service. Any buckling caused by thermal expansion of the subsea pipeline is distributed to two or more of the spaced-apart sections, causing the two or more spaced-apart sections to deflect laterally along the seafloor outwardly from an initial as-laid position.

### CROSS REFERENCE TO RELATED APPLICATIONS

This application claims priority benefit of U.S. Provisional Application No. 62/994,515 filed Mar. 25, 2020, which is incorporated herein by reference in its entirety.

### FIELD OF THE INVENTION

The present invention relates to a method for controlling buckling due to thermal expansion and, more specifically, to controlling buckling of deepwater pipelines with buoyancy modules.

### BACKGROUND OF THE INVENTION

As subsea production of oil and gas moves to greater depths, the effects of temperature and pressure become more challenging. The challenges are exacerbated by increasing pipeline lengths.

For example, in the Gulf of Mexico, production wells are deployed in water depths of 5,000 to 10,000 ft (1,500 to 3,000 m), even up to 15,000 ft (4,500 m). Accordingly, pipelines are subjected to High Pressure High Temperature (HPHT) conditions, for example, 10,000 to 20,000 psi (70 to 140 MPa) and 300° F. to 400° F. (150° C. to 200° C.). HPHT causes expansion of pipelines and, if expansion is restrained, for example by friction of the seabed, undesirable compressive axial forces are developed. When the force is large enough, the pipeline will buckle, potentially leading to fatigue, fracture, stress cracks, and/or rupture of the pipeline. Expansion and contraction of subsea pipelines may be caused by cycles of production start-up and shut-down, as an example.

Traditionally, the industry has controlled thermal buckling by trenching and burying the pipeline, using overburden to constrain buckling. However, under increased HPHT conditions and greater depths and lengths, the required overburden load is uneconomical. Accordingly, efforts have been made by the industry to artificially induce buckles in the pipeline.

One method for triggering buckles is to locally reduce weight of a pipeline through so-called distributed buoyancy modules. A distributed buoyancy module (DBM) is illustrated, for example, in Sun et al (“Thermal Expansion/Global Buckling Mitigation of HPHT Deepwater Pipelines, Sleeper or Buoyancy?” Proceedings of the Twenty-second (2012) International Offshore and Polar Engineering Conference Rhodes, Greece, Jun. 17-22, 2012).

A DBM is typically a two-part or three-part body of foam with an external clamp, an external strap and/or an internal clamp, for forming a clam-shell module around a pipeline. Conventionally, the coaxial DBMs are attached to the pipeline on a vessel, such as described in U.S. Pat. No. 8,573,888B2 (Technip) before the pipeline is lowered to the seabed. Each DBM can be quite large (for example, 6 ft×6 ft×3 ft (1.8 m×1.8 m×0.9 m) (length×width×height)). Accordingly, the pipeline with attached DBMs is quite cumbersome and requires a large vessel for laying the pipeline.

During pipeline buckling, conventional DBMs slide across the seabed in the lateral direction, undesirably resulting in soil compaction, increased lateral soil resistance and the formation of berms on the seabed. The berms create additional lateral resistance which diminishes the effectiveness of the buoyancy modules to alleviate the severity of pipeline buckling.

One method for overcoming the deficiencies of conventional DBMs for facilitating lateral movement of pipelines by reducing the effect of friction with the seabed is described in U.S. Pat. No. 8,721,222B2 (Mebarkia et al), which describes a rolling assembly that is fixed axially with respect to the pipeline. Later, U.S. Pat. No. 10,371,288B1 (Critsinelis et al) provides a rigid support structure for supporting a portion of the pipeline, the rigid support structure having at least two axles with at least four rotatable components for facilitating movement of the pipeline to reduce or eliminate lateral deformation and axial displacement of the pipeline.

U.S. Pat. No. 7,819,608B2 (Joshi et al) relates to a distributed buoyancy pipeline installation method. The method involves laying a section of negatively buoyant pipeline on a seabed on a first side of a topographic feature to be traversed. The topographic feature is selected from enormous basins, domes, valleys, cliffs, canyons, and escarpments, particularly steep slopes or cliffs (“drops of hundreds to over a thousand feet”). Another section of negatively buoyant pipeline is laid on the seabed on the other side of the topographic feature. A distributed buoyancy region is connected between the two sections to form a positively buoyant section. The combination of negatively buoyant sections and a positively buoyant section enables the pipeline to form a smooth, gradual S-curve to traverse the topographic feature.

As illustrated and discussed in Joshi et al, the distributed buoyancy region is a region of spaced circumferential buoys, but Joshi et al indicate that integral buoyancy features, applied buoyancy coating and tethered buoyancy elements can be used. In any case, the distributed buoyancy region is deployed by installing buoyancy devices to the pipeline as the installation vessel crosses the topographic feature. The buoyancy devices proceed down a lay apparatus, pipe lay stringer and into the water as the vessel traverses the topographic feature.

U.S. Pat. No. 9,663,193B2 and U.S. Pat. No. 8,961,071B2 (Critsinelis et al) relate to a system and method utilizing lifting buoyancy modules for lifting a pipeline in the event of a geo-hazard, such as a mudflow. Lifting buoyancy modules are attached to a subsea pipeline in a normally non-activated state and anchored to the seabed with anchoring tethers to constrain the pipeline from being lifted. An activation mechanism associated with the lifting buoyancy module is activated to detach the anchoring tether and to lift the pipeline off the seabed. The lifting buoyancy modules can then be reattached to the anchors, for example, by ROV, to return the pipeline to the seabed. The activation mechanism is triggered by an associated sensor (accelerometer, magnetometer, gyroscope, current meter, sound meter, vibration detector) capable of detecting a geo-hazard event.

DBMs are also used for towing and installing a pipeline for offshore production. For example, U.S. Pat. No. 7,993,077B2 (Alliot) relates to towing a pipeline through water, the pipeline having regions of DBMs to create peaks and troughs having a buoyancy variation from 50 to 400 N/m. Once the towing vessel has reached the desired location, the DBMs are progressively removed to allow the pipeline to sink and lay on the seabed.

The placement and spacing of DBMs on a pipeline are typically determined by finite-element analysis. As well, conventional DBMs are installed at the surface, before the pipeline is deployed. While Joshi et al place DBMs according to the location of enormous topographic features, none of the methods described above account for localized features that may impede desirable lateral buckling.

Also, conventional DBMs cannot be repositioned once attached to a pipeline and are not retrievable from a pipeline at the seafloor. As a result, a pipeline is not readily adaptable reconfiguration due to changes in operating conditions and, when a pipeline is decommissioned, the DBM is typically left in place.

There is a need for an improved method for controlling buckling of a deepwater pipeline that can be installed after a pipeline is laid. Advantageously, a buoyancy module could be repositioned on a pipeline in response to changes in operating conditions. It is also desirable to retrieve the buoyancy devices after a pipeline is decommissioned.

### SUMMARY OF THE INVENTION

According to one aspect of the present invention, there is provided a method for controlling buckling in subsea pipelines, comprising the steps of: providing a subsea pipeline on a seafloor, the subsea pipeline having an initial as-laid position; identifying a plurality of spaced-apart sections of the subsea pipeline suitable for controlled lateral buckling; installing a set of buoyancy modules at each spaced-apart section, the set of buoyancy modules installed in a spaced-apart relationship; wherein the set of buoyancy modules is selected to support the spaced-apart sections of the subsea pipeline in a neutrally buoyant condition at the seafloor when the subsea pipeline is in service; whereby any buckling caused by thermal expansion of the subsea pipeline is distributed to two or more of the spaced-apart sections, causing the two or more spaced-apart sections to deflect laterally along the seafloor outwardly from the initial as-laid position.

### BRIEF DESCRIPTION OF THE DRAWINGS

The method of the present invention will be better understood by referring to the following detailed description of preferred embodiments and the drawings referenced therein, in which:

FIG. 1 is a side elevation view of one embodiment of a set of buoyancy modules installed on a subsea pipeline;

FIG. 2A is a perspective view of one buoyancy module of the embodiment in FIG. 1;

FIGS. 2B-2D are perspective views of other embodiments of a buoyancy module;

FIG. 3 is an exploded view of a preferred embodiment of a buoyancy module assembly;

FIGS. 4A-4C are front elevation, top plan and side elevation views, respectively, of a preferred embodiment of a clamp, in an unlocked condition;

FIGS. 5A-5C are front elevation, top plan and side elevation views, respectively, of the clamp of FIGS. 4A-4C, in a locked condition;

FIGS. 6A-6E illustrate an example of the method of the present invention; and

FIG. 7 is a reproduction of a photograph illustrating a neutrally buoyant condition.

### DETAILED DESCRIPTION OF THE INVENTION

The present invention provides a method for controlling buckling in subsea pipelines, particularly for deepwater pipelines at a depth in a range of from 5,000 to 15,000 ft (1,500 to 4,500 m). The method of the present invention is suitable for pipelines subjected to a pressure in a range of from 5,000 to 20,000 psi (35 to 140 MPa) and 300° F. to 400° F. (150° C. to 200° C.).

In accordance with the method of the present invention, the method of the present invention overcomes the disadvantages of conventional DBMs by providing buoyancy modules that are installed after the pipeline is deployed in an as-laid position. The subsea pipeline may be laid according to conventional techniques, including, without limitation, an S-lay, J-lay or reel-lay process. The pipeline may be laid, for example, without limitation, in a straight or snake configuration.

After the subsea pipeline is deployed to the seafloor, an underwater vehicle, such as an ROV or an AUV, are used to install the buoyancy modules.

Finite Element Analysis (FEA) tools, such as, for example, without limitation, ABAQUS®, and/or other analytical tools are conventionally used by those skilled in the art to determine thermal mitigation effectiveness and reliability analysis when determining specifications of subsea pipelines and related components. Such tools are used to determine a preliminary proposed spacing between sets of buoyancy modules and to ensure that planned buckling occurs at the identified sections of pipeline and that no unplanned (rogue) buckling occurs between mitigation locations for various operating conditions. In accordance with the present invention, the actual spacing between sets of buoyancy modules and between buoyancy modules within a set is determined by inspecting the as-laid pipeline and environmental factors at the preliminary proposed sections of pipeline.

For example, post-installation inspection of the environment around a section of pipeline that is proposed for installation of a set of buoyancy modules may reveal rocks, spans for ditches, installation stresses, seabed slopes, changes in soil type, and the like. If a buoyancy module is installed at an undesirable environmental condition, distribution of buckling to these locations may not work or may adversely affect the pipeline and/or the buoyancy module. Advantageously, the method of the present invention provides that the sets of buoyancy modules can be spaced-apart to avoid obstacles and less desirable locations on the seafloor.

In accordance with the present invention, a plurality of spaced-apart sections of the subsea pipeline are identified as being suitable for controlled lateral buckling. The spacing of the sets of buoyancy modules is selected according to operating conditions. The spaced-apart sections preferably have a center-to-center distance in a range of from 2,000 to 10,000 ft (600 to 3,000 m), more preferably at a center-to-center distance in a range of from 3,000 to 5,000 feet (900 to 1500 m), even more preferably at a center-to-center distance in a range of from 2,500 to 4,500 ft (760 to 1,400 m).

At each section of the subsea pipeline identified for controlled buckling, a set of buoyancy modules are installed in a spaced-apart relationship. Each set of buoyancy modules has at least 3 buoyancy modules, preferably from 3 to 10 buoyancy modules, more preferably from 3 to 7 buoyancy modules. In a preferred embodiment, each set of buoyancy modules has 5 buoyancy modules. The buoyancy modules are installed in a spaced-apart relationship at a center-to-center distance in a range of from 40 to 100 ft (12 to 30 m).

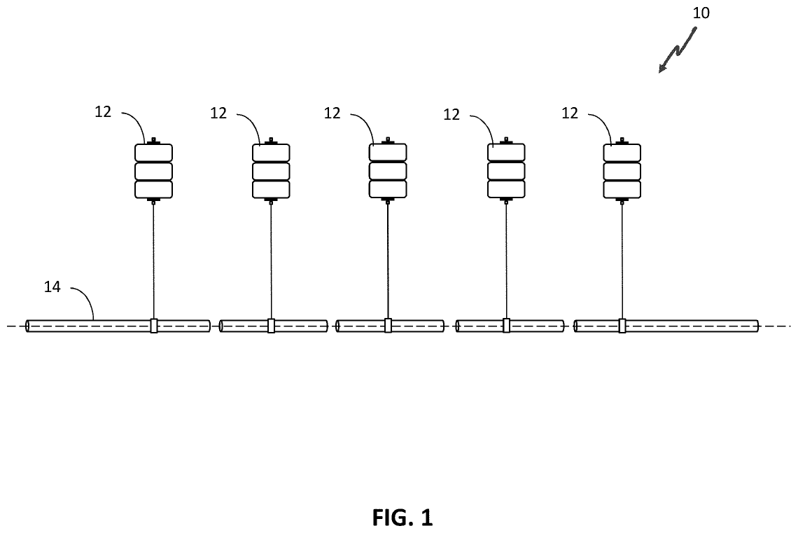

FIG. 1 illustrates an embodiment of the present invention 10, wherein a set of five buoyancy modules 12 is installed on an as-laid subsea pipeline 14. Each of the buoyancy modules 12 within the set are spaced-apart at a center-to-center distance of 40 to 100 feet (12 to 30 m). The buoyancy modules 12 are vertically oriented relative to the pipeline 14.

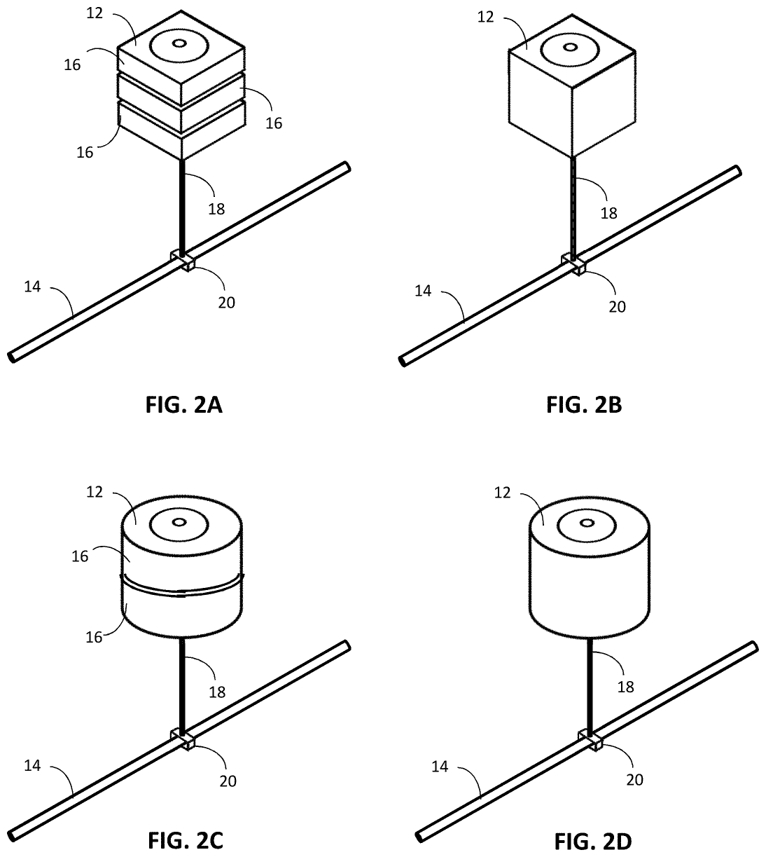

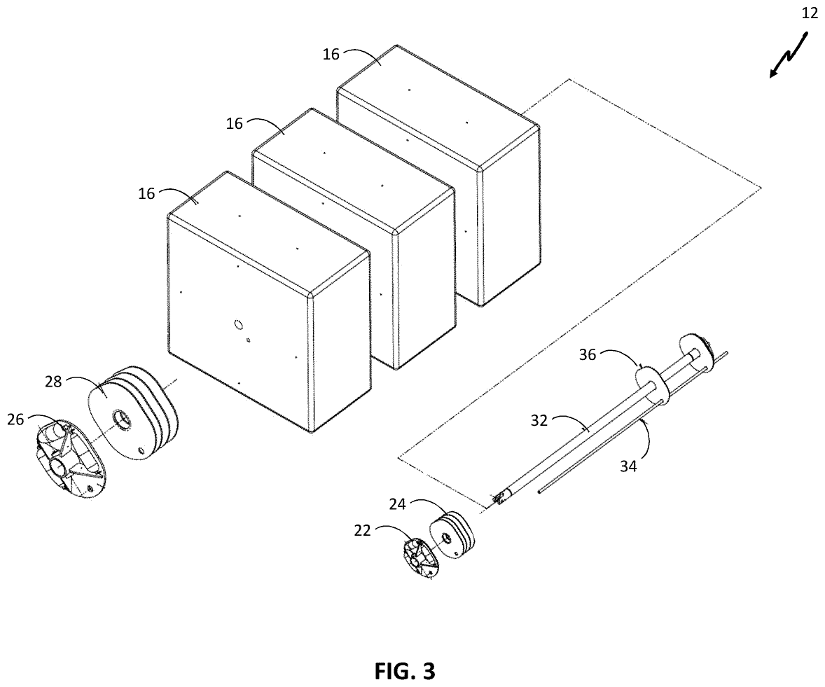

Suitable embodiments of the buoyancy module 12 are illustrated in FIGS. 2A-2D. Other shapes and dimensions may be contemplated by those skilled in the art. The buoyancy module 12 illustrated in FIG. 2A has three modular sections 16 that are square in cross-section. It will be understood by those skilled in that art that other cross-sectional shapes can be used and that each of the three modular sections 16 can be the same or different height and/or width. It will also be understood that the number of modular sections 16 used in a set of buoyancy modules 12 may be the same or different. For example, depending on the subsea conditions, it may be desirable to have a center buoyancy module with three modular sections 16 with flanking buoyancy modules 12 with two modular sections 16.

The buoyancy module 12 illustrated in FIG. 2B has a unitary body. In FIG. 2C, the buoyancy module 12 has two cylindrical modular sections 16, while FIG. 2D depicts a unitary cylindrical body.

The buoyancy modules 12 may be formed of materials that would remain buoyant under deepwater conditions for the life of the subsea production. Examples of suitable materials include, without limitation, polyurethane foams, macro- or micro-sphere system syntactic foam, and combinations thereof. The buoyant material may be protected with an outer coating.

In accordance with the present invention, the buoyancy modules 12 lift a section of the pipeline 14 to neutral buoyancy. By “neutral buoyancy,” we mean that the section of the pipeline 14 is buoyed to approximately 0 LBF (0 N), so that pipeline embedment and the interaction with the seafloor is limited. Accordingly, we mean that the material, structure, spacing and number of buoyancy modules 12 is selected to provide sufficient buoyancy to support 80 to 100% of the weight of the in-service section of pipeline 14 at the seafloor. Preferably, this buoyancy determination accounts for changes in buoyancy over the life of service. For example, a buoyancy material may have a water absorption of about 3% over the life of service. Accordingly, the target buoyancy is preferably determined for supporting 80 to 100% of the weight of the section of pipeline at the end of the life of service of the buoyancy module. As well, the target buoyancy factors weight of the attachment components (for example, clamps 20). A neutral buoyancy condition reduces soil resistance during lateral deflection of the section of the pipeline 14.

The neutral buoyancy condition for each set of buoyancy modules 12 is impacted by controlling the number and spacing of the buoyancy modules 12, the material of the buoyancy modules 12, the shape and size of the buoyancy module 12, and the like.

The neutral buoyancy at selected pipeline sections reduces the resistance to lateral movement along the seafloor. By “lateral movement,” we mean lateral deflection of the pipeline from an as-laid condition. Depending on the conditions and the seafloor, there may also be some vertical deflection. In accordance with the present invention, any buckling caused by thermal expansion of the subsea pipeline is distributed to two or more of the spaced-apart sections, causing the two or more spaced-apart sections to deflect laterally along the seafloor outwardly from the initial as-laid position. In practice, the inventors have found that the lateral deflection is substantially equally distributed to each of the spaced-apart sections of pipeline 14. In accordance with the present invention, the reduced resistance to lateral movement in spaced-apart sections of pipeline allows controlled buckling of the pipeline in at least two sections of the pipeline in response to thermal expansion.

The inventors have discovered that the method of the present invention allows for lateral deflection of the sections of subsea pipeline 14 during hot cycles and that, during cold cycles, the sections of subsea pipeline 14 gradually return substantially to the as-laid position of the section of pipeline 14.

The buoyancy modules 12 are attached to the subsea pipeline 14 in a manner that allows for independent movement of the buoyancy module 12 relative to the pipeline 14, thereby allowing the buoyancy module 12 to move in response to currents, bumps from passing objects, and the like without affecting the position of the pipeline 14. Preferably, the buoyancy module 12 is clamped to the subsea pipeline 14 with a clamp 20. The buoyancy module 12 may be attached to the clamp 20 with a flexible joint or a simple link. In a preferred embodiment, the buoyancy module 12 is attached to the clamp 20 with a tether 18. The tether 18 may be formed of metal or synthetic material capable of withstanding deepwater conditions for the life of the subsea production. Preferably, the tether 18 is formed of a synthetic rope.

The length of the tether 18 is selected to long enough for ease of installation, but not so long that buoyancy modules 12 interfere with one another or become adversely affected by environmental conditions, such as currents. Preferably, the tether 18 has a length in a range of from 5 to 20 ft (1.5 to 6 m).

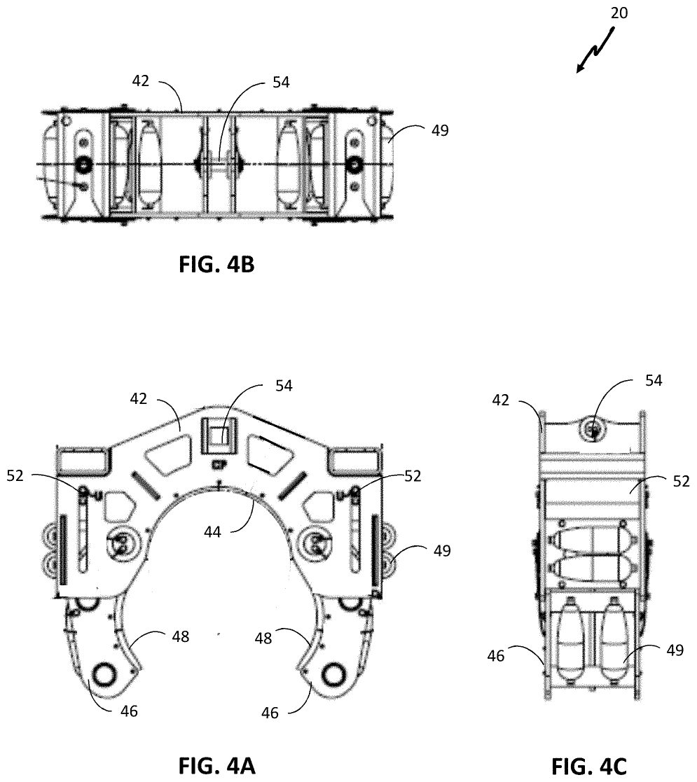

FIG. 3 illustrates a preferred embodiment of the buoyancy module 12 of FIG. 2A. For ease of drawing review, fasteners, cathodic protection devices and grounding straps are not shown. Modular sections 16 are held together between a top center lift plate 22 and a bottom center plate 26. One or more spacers 24, 28 are optionally added to further secure the top center lift plate 22 and the bottom center plate 26, respectively. Rod 32 traverses from the top center lift plate 22 to the bottom center plate 26 through a center hole in the modular sections 16. The rod 32 is connected to each of the top center left plate 22 and the bottom center plate 26 with the appropriate fasteners (not shown). Preferably, a pin 34 also traverses from the top center lift plate 22 to the bottom center plate 26 through an off-center hole in the modular sections 16 to stabilize the modular sections 16 relative to one another. Optional spacers 36 may be used between modular sections 16.

The top center lift plate 22 is provided with an eyelet (not shown) to provide a lifting point for installing the buoyancy module 12. The bottom center plate 26 is provided with an eyelet (not shown) for connection to the tether 18.

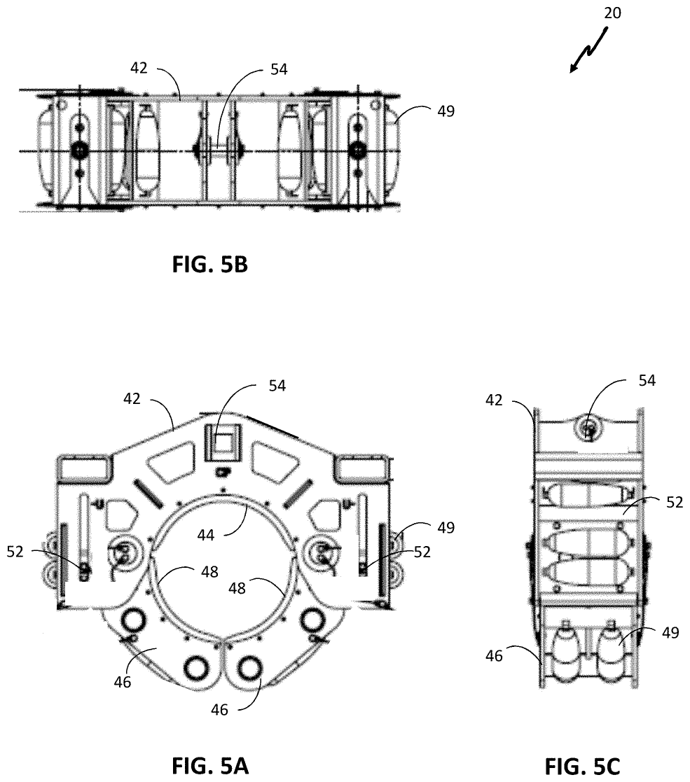

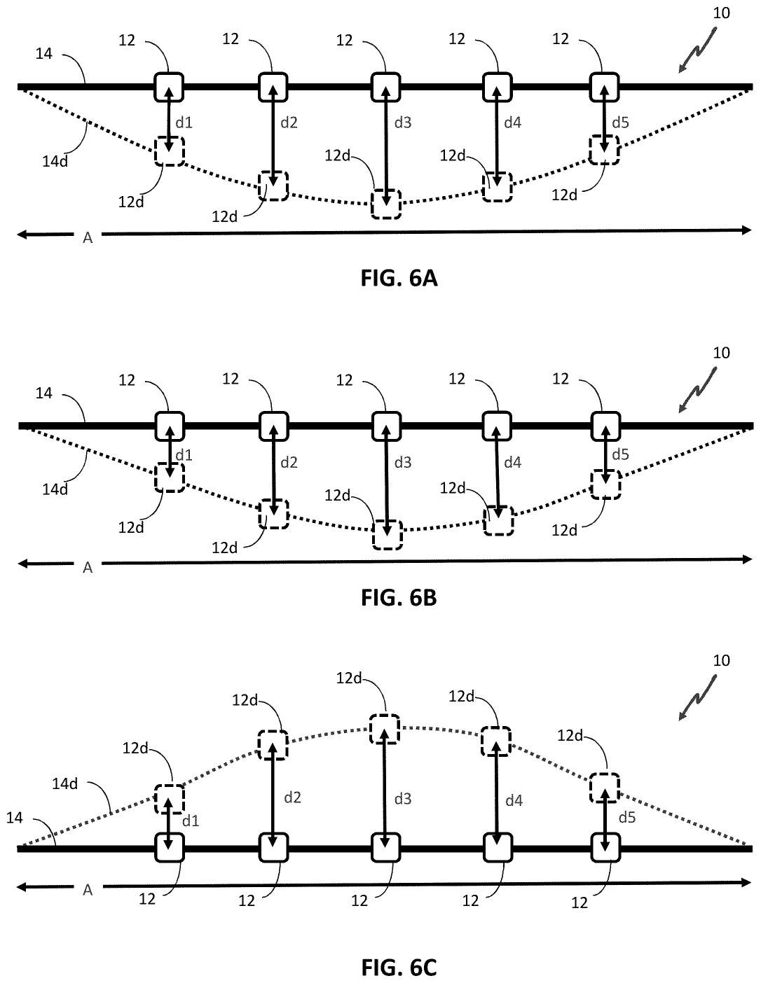

Turning now to FIGS. 4A-4C and FIGS. 5A-5C, illustrating a preferred embodiment of a clamp 20 for securing the buoyant module 12 to the pipeline 14, a clamp has a top body 42, with an arcuate surface 44 defining a portion of a circumference of a pipeline 14. The arcuate surface 44 is preferably provided with a compressible material, such as a rubber or synthetic polymer, to grasp and protect the pipeline 14. Clamp jaws 46 are hingedly connected to each side of the top body 42. The clamp jaws 46 have arcuate surfaces 48 to cooperate with the arcuate surface 44 such that, when the clamp is in a locked condition, the arcuate surfaces 46,48 define a substantial portion or all of the circumference of a pipeline 14. Preferably, the clamp 20 is provided with cathodic protection, for example with anodes 49.

The clamp 20 is provided with a locking mechanism, for example, a wedge plate 52, for urging the clamp jaws 46 from an unlocked condition, as shown in FIGS. 4A-4C, to a locked condition, as shown in FIGS. 5A-5C.

In use, the clamp 20 is installed at a desired location in an unlocked condition. The locking mechanism is activated to hingedly rotate the clamp jaws 46 around a bottom portion of the circumference of the pipeline 14. The top body 42 is provided with an eyelet 54 for connecting to a tether 18, which, in turn, is connected to a buoyancy module 12.

The clamp 20 illustrated in FIGS. 4A-4C and FIGS. 5A-5C is advantageously used to enable the buoyancy modules 12 and clamps 20 to be removably attached to the subsea pipeline. This allows for the buoyancy modules 12 and clamps 20 to be removed once a pipeline 14 is decommissioned. Another advantage is the buoyancy modules 12 and clamps 20 may be replaced and/or reused.

In accordance with the present invention, the buoyancy modules 12 can be adjusted for different operation conditions and production life extension, accounting for changes in temperature and/or pressure in different production phases (early phase, middle phase, later phase, and extension phase). For example, the spacing between buoyancy modules 12 and/or sets of buoyancy modules 12 may be changed in response to a change of service of the pipeline 14.

### Example

The following non-limiting example of an embodiment of the method of the present invention as claimed herein is provided for illustrative purposes only.

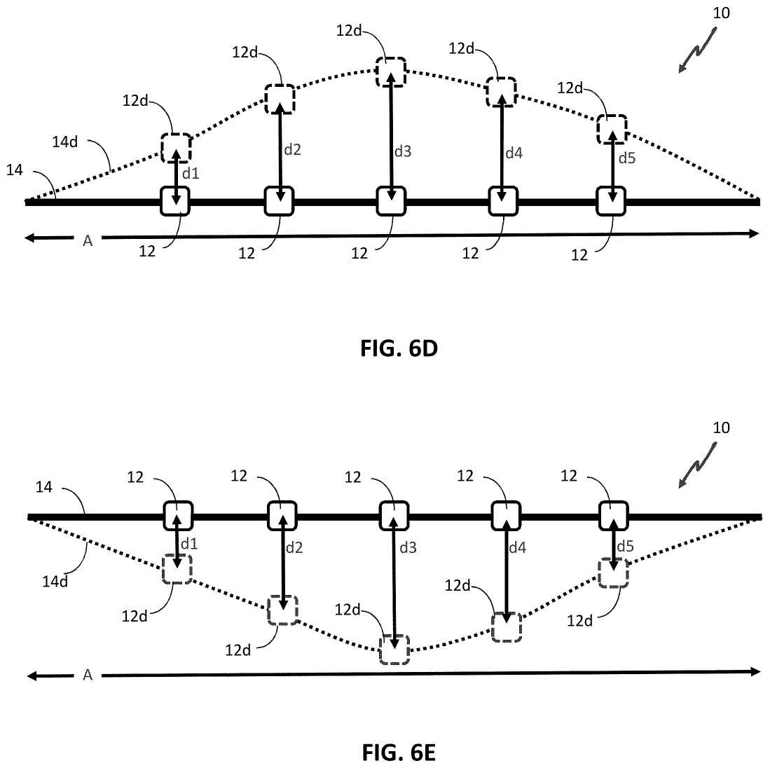

A 21,000 ft (6,400 m) long production pipeline was installed on a soft clay seafloor in the Gulf of Mexico. The pipeline had an outer diameter of 10.75 inches (27 cm). FIGS. 6A-6E illustrate the as-laid pipeline 14. Five sets of buoyancy modules were installed on the pipeline 14 at 1,900 ft (580 m) as shown in FIG. 6A, 5,950 ft (1,800 m) as shown in FIG. 6B, 10,000 ft (3,000 m) as shown in FIG. 6C, 14,050 ft (4,300 m) as shown in FIG. 6D, and 18,100 ft (5,500 m) as shown in FIG. 6E, respectively, from the production well. Each set of buoyancy modules had five buoyancy modules 12 spaced approximately 60 ft (18 m) apart. The buoyancy modules 12 support their respective sections of pipeline 14 in a neutrally buoyant position at the seafloor. The targeted buoyancy for each set of buoyancy modules 12 was 95% of the weight of the in-service pipeline 14 at the seafloor and accounted for 3% absorption of water over the life of the buoyancy module 12.

The pipeline was cycled through hot and cold cycles, in accordance with operations. During the hot production cycle, the temperature and pressure as measured at the corresponding PLET (pipeline end termination) was 313° F. (156° C.) and 5,066 psi (35 MPa). The pipeline 14 was subjected to thermal expansion during the hot cycle. Buckling was distributed substantially equally to the sections of pipeline 14 where Sets 1-5 of the buoyancy modules 12 were installed. The sections of pipeline 14 at each of the Sets 1-5 were deflected laterally along the seafloor outwardly from the initial as-laid position to a deflected position 14d.

The buckle length A and the lateral deflection d1-d5 of each buoyancy module deflection 12d is listed in Table I.

TABLE I

| | Set 1 | | Set 2 | | Set 3 | | Set 4 | | Set 5 | |
|---|---|---|---|---|---|---|---|---|---|---|
| Distance from | 1,900 | ft | 5,940 | ft | 10,000 | ft | 14,050 | ft | 14,050 | ft |
| Production Well | (580 | m) | (1,800 | m) | (3,000 | m) | (4,300 | m) | (4,300 | m) |
| Buckle Length (A) | 566 | ft | 506 | ft | 499 | ft | 520 | ft | 491 | ft |
| | (173 | m) | (154 | m) | (152 | m) | (158 | m) | (150 | m) |
| Lateral deflection | 8-9 | ft | 8 | ft | 8-9 | ft | 7 | ft | 9 | ft |
| (d1) | (2.4-2.7 | m) | (2.4 | m) | (2.4-2.7 | m) | (2.1 | m) | (2.7 | m) |
| Lateral deflection | 22 | ft | 27 | ft | 27 | ft | 25 | ft | 25 | ft |
| (d2) | (6.7 | m) | (8.2 | m) | (8.2 | m) | (8.3 | m) | (8.3 | m) |
| Lateral deflection | 26 | ft | 34 | ft | 35 | ft | 34 | ft | 35 | ft |
| (d3) | (7.9 | m) | (10.4 | m) | (10.7 | m) | (10.4 | m) | (10.7 | m) |
| Lateral deflection | 22 | ft | 29 | ft | 29 | ft | 27 | ft | 28 | ft |
| (d4) | (6.7 | m) | (8.8 | m) | (8.8 | m) | (8.2 | m) | (8.5 | m) |
| Lateral deflection | 9 | ft | 11 | ft | 12 | ft | 12 | ft | 9 | ft |
| (d5) | (2.7 | m) | (3.4 | m) | (2.7 | m) | (3.7 | m) | (2.7 | m) |

When the pipeline was cycled to a cold condition at seafloor ambient conditions, the pipeline 14 was inspected and found to have returned to its as-laid position.

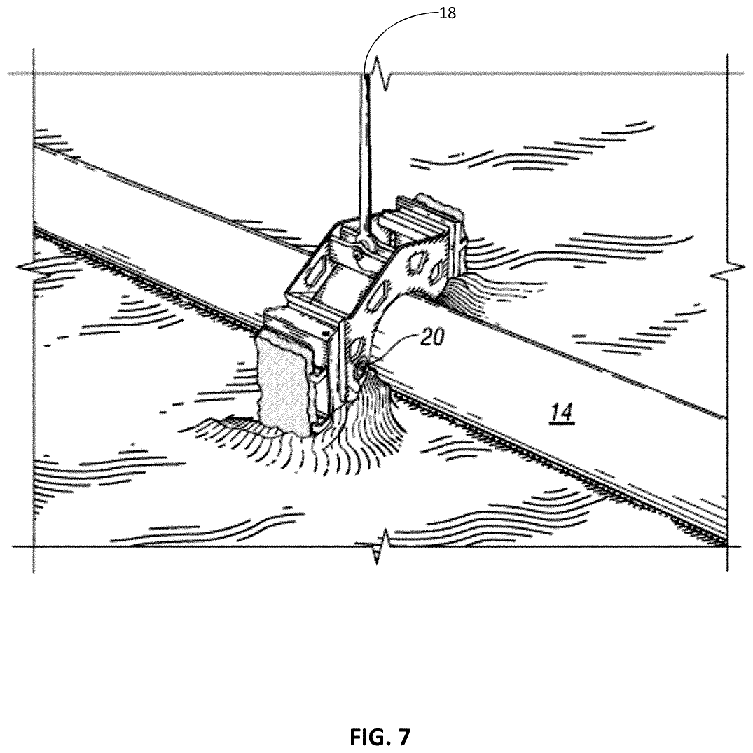

FIG. 7 illustrates an example of a neutrally buoyant condition of a pipeline 14 deployed in the Gulf of Mexico at a depth of 7,400 ft (2,300 m). The reproduction of a subsea photograph shows the pipeline 14 is resting at the mud-line. Some mud has settled on top of the clamp 20 and the pipeline 14. The upwardly extending tether 18 connects the buoyancy module 12 (not shown) to the clamp 20.

While preferred embodiments of the present invention have been described, it should be understood that various changes, adaptations and modifications can be made therein within the scope of the invention(s) as claimed below.

What is claimed is:

1. A method for controlling buckling in subsea pipelines, comprising the steps of:
providing a subsea pipeline on a seafloor, the subsea pipeline having an initial as-laid position;
identifying a plurality of spaced-apart sections of the subsea pipeline suitable for controlled lateral buckling;
installing a set of buoyancy modules at each spaced-apart section, each buoyancy module in the set of buoyancy modules installed in a spaced-apart relationship;
wherein the set of buoyancy modules is selected to support the spaced-apart sections of the subsea pipeline in a neutrally buoyant condition at the seafloor when the subsea pipeline is in service;
whereby any buckling caused by thermal expansion of the subsea pipeline is distributed to two or more of the spaced-apart sections, causing the two or more spaced-apart sections to deflect laterally along the seafloor outwardly from the initial as-laid position.

2. The method of claim 1, wherein the neutrally buoyant condition is achieved with a set of buoyancy modules selected to support 80 to 100% of an in-service weight of the section of the subsea pipeline at the seafloor.

3. The method of claim 1, wherein the subsea pipeline is deployed on the seafloor at a depth in the range of from 5,000 to 15,000 ft (1,500 to 4,500 m).

4. The method of claim 1, wherein the spaced-apart sections of the subsea pipeline are spaced at a center-to-center distance in a range of from 2,000 to 10,000 feet (600 to 3,000 m).

5. The method of claim 1, wherein the spaced-apart sections of the subsea pipeline are spaced at a center-to-center distance in a range of from 3,000 to 5,000 feet (900 to 1500 m).

6. The method of claim 1, wherein the spaced-apart sections of the subsea pipeline are spaced at a center-to-center distance in a range of from 2,500 to 4,500 ft (760 to 1,400 m).

7. The method of claim 1, wherein the set of buoyancy modules has at least 3 buoyancy modules.

8. The method of claim 1, wherein the set of buoyancy modules has from 3 to 10 buoyancy modules.

9. The method of claim 1, wherein the set of buoyancy modules has from 3 to 7 buoyancy modules.

10. The method of claim 1, wherein the set of buoyancy modules 5 buoyancy modules.

11. The method of claim 1, wherein each buoyancy module in the set of buoyancy modules is installed in a spaced-apart relationship at a center-to-center distance in a range of from 40 to 100 feet (12 to 30 m).

12. The method of claim 1, wherein each buoyancy module in the set of buoyancy modules is removably attached to the subsea pipeline.

13. The method of claim 1, wherein each buoyancy module in the set of buoyancy modules is vertically oriented relative to the pipeline.

14. The method of claim 1, wherein the subsea pipeline is subjected to pressures in a range of from 5,000 to 20,000 psi (35 to 140 MPa) and 300° F. to 400° F. (150° C. to 200° C.).

15. The method of claim 1, wherein the set of buoyancy modules is installed using an underwater vehicle.
